(19) United States
(12) Patent Application Publication
(10) Pub. No.: US 2004/0117295 A1
(43) Pub. Date: Jun. 17, 2004

(54) Real-time extraction, display and user management system for loan rate information

(76) Inventor: Greg Maliwanag, Irvine, CA (US)

Correspondence Address: Bruce B. Brunda, STETINA BRUNDA GARRED & BRUCKER, Suite 250, 75 Enterprise, Aliso Viejo, CA, 92656, US

(21) Appl. No.: 10/317,790

(22) Filed: Dec. 12, 2002

(51) Int. Cl. G06F 17/60

(52) U.S. Cl. 705/38

(57) ABSTRACT

A method for automatically, generating a summary of loan rates offered by multiple lenders is disclosed. A predefined list of identifications of web pages of the lenders from which loan rates are available is obtained. Such a list must have previously been stored, for example on a server that is performing the loan rate acquisition. The web pages identified for each of the lenders having available loan rates are requested. Web page responses are received from the lenders. The loan rates are extracted, independently of operator intervention, from each of the web page responses. The extracted loan rates are grouped to generate a summary of loan rates for the lenders. The process described above is periodically repeated to generate an updated summary of available loan rates from the lenders. The process may be repeated upon receipt of a user request and/or on a periodic timed basis.

### CROSS-REFERENCE TO RELATED APPLICATIONS

(Not Applicable)

### STATEMENT RE: FEDERALLY SPONSORED RESEARCH/DEVELOPMENT

(Not Applicable)

### BACKGROUND OF THE INVENTION

The present invention relates generally to the mortgage industry and more particularly to a method of automatically accumulating and updating mortgage rate information from various lenders and organizing the information for ease of comparison of rates.

Mortgage lenders compete for loans arranged by mortgage brokers. When a broker is looking to obtain a mortgage, he compares rate information (e.g., interest rate, points, closing costs) from various lenders to try to find the best loan for the customer. Lenders change rates frequently, sometimes several times a day. The rates are typically communicated to the mortgage broker either by fax or by e-mail. The faxes may be posted on bulletin boards in the broker's office where various people working under the mortgage broker can review and compare the information. A considerable amount of time may be lost in trying to accumulate the current information from various e-mail and fax sources in order to compare and obtain the best deal.

Therefore, a need exists for a system that automatically collects rate information from various lenders and organizes the collected information in a manner that allows the user (e.g., borrower or lender) to easily compare rates from the various lenders.

### BRIEF SUMMARY OF THE INVENTION

A centralized computer-implemented method for automatically, generating a summary of loan rates offered by a plurality of lenders is disclosed. A predefined list of a plurality of identifications of web pages of lenders from which loan rates are available is obtained. Such a list must have previously been stored, for example on the server which is performing the loan rate acquisition. The web pages identified for each of the lenders having available loan rates are requested. Web page responses are received from the lenders. The loan rates are extracted, independently of operator intervention, from each of the web page responses. The extracted loan rates are grouped into a predefined format thereby generating a summary of loan rates for the plurality of lenders.

The process described above is periodically repeated to generate an updated summary of available loan rates from the lenders. The process may be repeated upon receipt of a user request for the summary of loan rates and/or on a periodic timed basis.

Preferably, prior to performing any functions, the user logs in. The login procedure should be a secure procedure.

In exemplary embodiments, a timeout occurs if there is no activity from the user for a predefined period of time. If a timeout occurs, the user is required to log in again.

The format for each of the web pages of the lenders may be known and the loan rates are extracted from each of the web pages based on the known format of the web page for the respective lender. Alternatively, the web page formats for all of the lenders may not be known and the loan rates are extracted using an algorithm comprising scanning the web pages for key words.

The loan rate information may be displayed and/or printed.

Users may be administrators and be able to perform administrator functions. Administrative functions may include viewing information about registered users, displaying detailed information for a particular user and/or adding a note about a particular user.

The loan rates information may be mortgage loan rates.

Communications may occur over a network. The network may be the Internet.

### BRIEF DESCRIPTION OF THE DRAWINGS

These as well as other features of the present invention will become more apparent upon reference to the drawings wherein:

FIG. 1 is a block diagram illustrating the main components of a computer-implemented system for automated, real-time acquisition of loan rate information from multiple lenders;

FIG. 2 is a flow diagram illustrating exemplary logic performed by the server of the loan rate acquisition system shown in FIG. 1;

FIG. 3 illustrates exemplary logic for a registration process of the loan rate acquisition system shown in FIG. 2;

FIG. 4 illustrates exemplary logic for an administrator process of the loan rate acquisition system shown in FIG. 2;

FIG. 5 illustrates specific functions available from the administrator process of FIG. 4;

FIG. 6 illustrates exemplary logic for a general user process of the loan rate acquisition system shown in FIG. 2; and

FIG. 7 illustrates specific functions available from the general user process of FIG. 6.

### DETAILED DESCRIPTION OF THE INVENTION

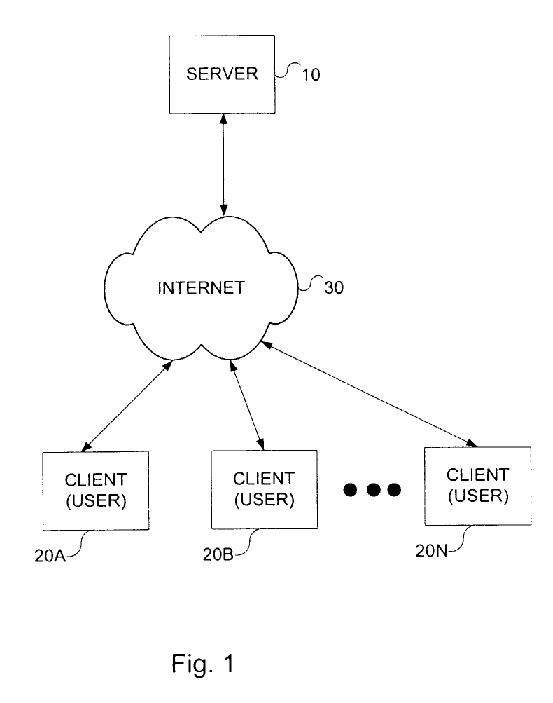

Referring now to the drawings wherein the showings are for purposes of illustrating preferred embodiments of the present invention only, and not for purposes of limiting the same, FIG. 1 is a block diagram illustrating the main components of a loan (e.g., mortgage loan) rate acquisition system formed in accordance with the present invention. The system includes a server 10. The server 10 is a computer system having sufficient resources for implementing logic (software) as described herein. Any one of various types of hardware/operating system configurations may be used to implement the present invention. Such computer systems are known in the art and are not described in further detail herein.

Client computers 20A, 20B, 20N can access the logic on the server 10. Users (e.g., mortgage brokers, borrowers, etc.) can access the information via a network, such as the Internet 30. The user requests a web page. For example, the user enters a Uniform Resource Locator (URL) for the home page of the server 10. The web page is transmitted from the server 10 to the client 20A, 20B or 20N requesting the web page. As described below, in exemplary embodiments, the requested web page is the home page which includes a user login requesting a username and password.

The server 10 is in communication with a data repository (e.g., database) that includes records for all of the registered users. In exemplary embodiments, a user may be a general user or an administrator. Depending on the type of user, a web page is displayed that allows the user to perform the functions available based on the user type. For example, general users can view and/or print loan (e.g., mortgage loan) rate information. An administrator can perform administrative functions, such as viewing a list of all users and viewing information about the registered users, in addition to being able to perform any of the functions that a general user can perform.

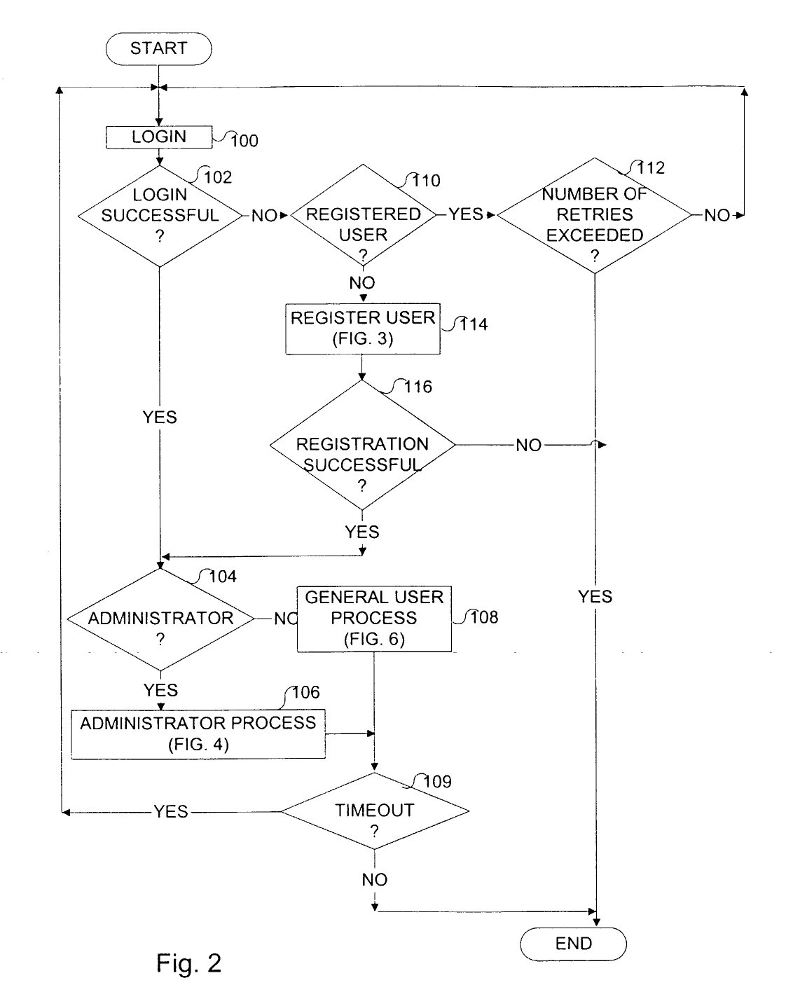

FIG. 2 is a flow diagram illustrating exemplary logic for a loan rate acquisition system formed in accordance with the present invention. In the exemplary embodiment shown and described herein, the system is a client/server system in which the clients 20A, 20B, 20N communicate with the server 10 over a network 30, such as the Internet. When the user 20A, 20B or 20N accesses the website (e.g., enters the URL), the logic of FIG. 2 is performed.

The logic of FIG. 2 moves from a start block to block 100 where a login procedure is performed. Preferably, the login procedure is a secure procedure, for example using known security techniques, such as, Hyper Text Transfer Protocol Secure Sockets (HTTPS). In exemplary embodiments, a login form is displayed. The login form requests a username and password. Upon entry of the username and password, the data (username/password) is validated.

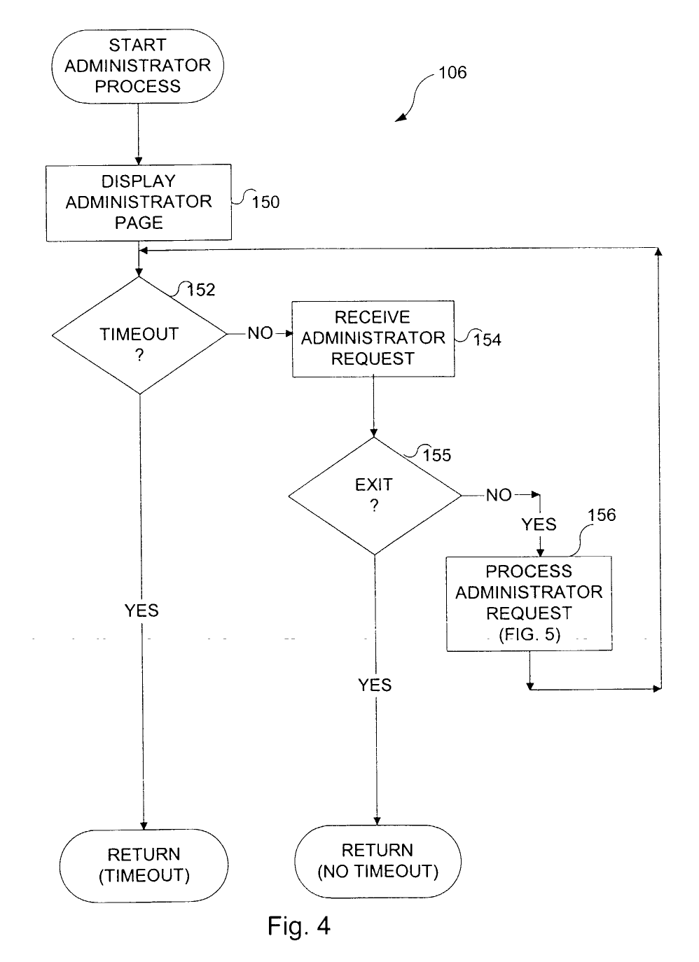

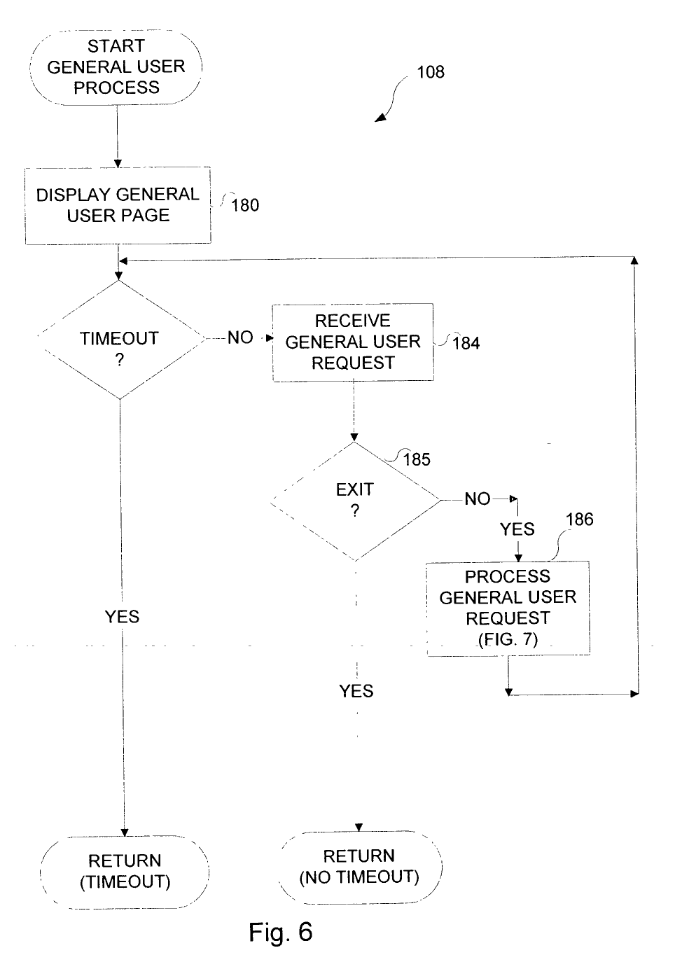

If the login is successful (yes in decision block 102), the logic moves to decision block 104 to determine if the registered user is an administrator. If so, the logic moves to block 106 where an administrator process is performed. Exemplary logic for an administrator process is shown in FIG. 4 and described later. If the user is not an administrator (no in decision block 104), the logic moves from decision block 104 to block 108 where a general user process is performed. Exemplary logic for a general user process is shown in FIG. 6 and described later.

If the login is not successful (no in decision block 102), the logic moves to decision block 110 to determine if the user is a registered user. If the user is a registered user (yes in decision block 110), the logic moves to decision block 112 to determine if the number of re-tries has been exceeded. In exemplary embodiments, there is a predefined number of login attempts, for example three. If a valid username is entered but the password entered is incorrect, and the retry limit has not been exceeded (no in decision block 112), the logic returns to block 100 where the user can attempt to login again. If the number of re-tries has been exceeded (yes in decision block 112), the logic of FIG. 2 ends.

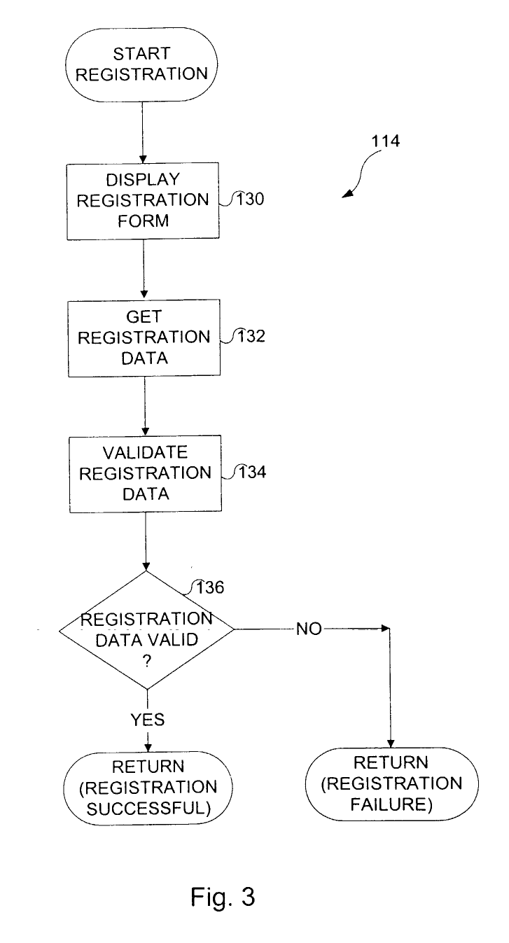

If the user is not a registered user (no in decision block 110), the logic moves to block 114 where a registration process is performed. FIG. 3 illustrates exemplary logic for a registration process and is described next.

The logic of FIG. 3 moves from a start block to block 130 where a registration form is displayed on the client computer 20A, 20B or 20N. The logic proceeds to block 132 where the registration data is obtained. For example, once the user has entered the data, the user indicates completion by pressing a submit button. The data is then transmitted from the client computer 20A, 20B or 20N to the server 10. Once the data is obtained, the data is validated. See block 134. The logic then moves to decision block 136 to determine if the registration data is valid. If so, the registration is successful and the logic of FIG. 3 ends and processing returns to FIG. 2 with an indication that the registration was successful. If the registration data is not valid (no in decision block 136), the registration is not successful and the logic of FIG. 3 ends and processing returns to FIG. 2 with an indication that the registration failed.

Returning to FIG. 2, the logic moves from block 114 to decision block 116 to determine if the registration was successful. If the registration was not successful (as indicated by the return status from FIG. 3), the logic of FIG. 2 ends.

If the registration was successful (as indicated by the return status from FIG. 3), the logic moves from decision block 116 to decision block 104 to determine if the user is an administrator. For example, owners of the server 10 may be administrators. In exemplary embodiments, certain other users may also have administrator privileges, for example, mortgage brokers paying an administrator subscription fee. If the user is an administrator, the logic moves from decision block 104 to block 106 where an administrator process is performed. Exemplary logic for an administrator process is shown in FIG. 4 and described below. If a user is not an administrator (no in decision block 104), the logic moves to block 108 where a general user process is performed. Exemplary logic for performing a general user process is shown in FIG. 6 and described later.

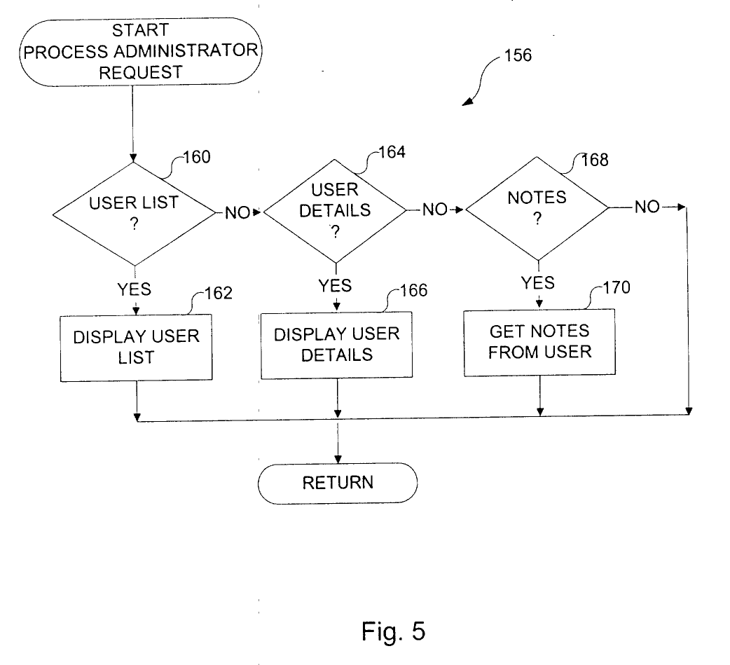

FIG. 4 illustrates exemplary logic for performing an administrator process. The logic moves from a start block to block of 150 where an administrator page is displayed. The administrator page includes access to administrator functions such as those shown in FIG. 5 and described later. In exemplary embodiments, the administrator page also allows access to the functions available to a general user such as those shown in FIG. 6 and described later.

In exemplary embodiments, if there is no activity from the user for a predetermined period of time (e.g., twenty minutes), a timeout occurs (yes in decision block 152) and the logic of FIG. 4 ends and processing is returned to FIG. 2 with an indication that a timeout occurred. As shown in FIG. 2, if a timeout occurs (yes in decision block 109), the user must login again (block 100).

Referring again to FIG. 4, if a timeout has not occurred (no in decision block 152), the logic moves to block 154 were an administrator request is received. For example, the user selects a function from the administrator web page. The request is then processed. If the user wishes to exit (e.g., selecting a logout function or entering a different URL), the logic of FIG. 4 ends and processing returns to FIG. 2. If, however, it is not time to exit (no in decision block 155), the logic moves to block 156 where the administrator request received is processed. FIG. 5 illustrates exemplary logic for processing an administrator request.

FIG. 5 illustrates administrator functions for an exemplary embodiment. The functions of the exemplary embodiment shown and described herein include displaying a user list, displaying details for a user selected from the user list and adding notes. It will be appreciated that various embodiments may include a subset of these functions, additional functions, or some combination thereof. As mentioned above, preferably, the administrator can perform all of the functions available to a general user in addition to being able to perform the administrator functions.

The logic of FIG. 5 moves from a start block to decision block 160 to determine if the user request was to display the user list. If so, the logic moves to block 162 where the list of registered users is displayed. In exemplary embodiments, the user list shows all registered users listed alphabetically by last name and displays the name, e-mail address and status (e.g., active/inactive/new registration) for each of the users listed. The list also includes links that allow the user to access more details and/or notes for a selected user. It will be appreciated that other embodiments may show different information and/or allow the user to customize the information displayed and/or change the sorting format for the information.

If the request is to view user details (yes in decision block 164), the logic moves to block 166 where details about a selected user are displayed. For example, all of the registration information may be displayed for the selected user, as well as the last login date/time and notes. In exemplary embodiments, the administrator may activate or inactivate a user account for the selected user.

If the user request is notes (yes in decision block 168), the logic moves to block 170 where a window is displayed that allows the administrator to enter any information that is desired about a selected user. Preferably, the note function may be accessed from the user list display or from the user detail display. In exemplary embodiments, the note is stamped with the name of the administrator that entered the note as well as the date and time that the note was entered.

After the user performs a function (block 162, block 166 or block 170), the logic of FIG. 5 ends and processing returns to FIG. 4.

Returning to FIG. 4, after an administrator request has been processed, the logic returns to block 152. Administrator functions are performed until a timeout occurs (yes in decision block 152) or until it is time to exit (yes in decision block 155). If a timeout occurs, the logic returns to block 100 where the user must login again. If it is time to exit, the logic of FIG. 4 ends and processing returns to FIG. 2.

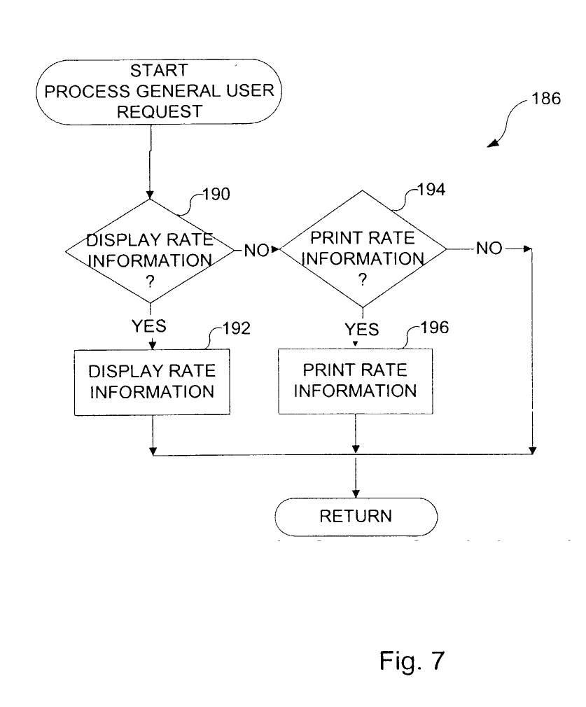

FIG. 6 illustrates exemplary logic for performing a general user process. The logic of FIG. 6 of performing a general user process is essentially the same as that shown in FIG. 4 for performing an administrator process except that the functions available to the user are different. The logic of FIG. 6 moves from a start block to block of 180 where a general user page is displayed. The general user page includes access to general user functions such as those shown in FIG. 7 and described later.

In exemplary embodiments, if there is no activity from the user for a predetermined period of time (e.g., twenty minutes), a timeout occurs (yes in decision block 182) and the logic of FIG. 6 ends and processing is returned to FIG. 2 with an indication that a timeout occurred. As shown in FIG. 2, if a timeout occurs (yes in decision block 109), the user must login again (block 100).

Referring again to FIG. 6, if a timeout has not occurred (no in decision block 182), the logic moves to block 184 were a general user request is received. For example, the user selects a function from the general user web page. The request is then processed. If the user wishes to exit (e.g., selecting a logout function or entering a different URL), the logic of FIG. 6 ends and processing returns to FIG. 2. If, however, it is not time to exit (no in decision block 185), the logic moves to block 186 where the general user request received is processed. FIG. 7 illustrates exemplary logic for processing a general user request.

FIG. 7 illustrates general user functions for an exemplary embodiment. The functions of the exemplary embodiment shown and described herein include displaying loan rate information and printing loan rate information. It will be appreciated that various embodiments may include a subset of these functions, additional functions, or some combination thereof. For example, the user could e-mail the information to an e-mail address specified by the user, the user could sort the information, for example, alphabetically by lender, based on interest rate, based on points, based on annual percentage rate (APR), etc.

The logic of FIG. 7 moves from a start block to decision block 190 to determine if the user request was to display rate information. If so, the logic moves to block 192 where the rate information is displayed. The loan information is obtained from the institutions on a real-time basis. In exemplary embodiments, the loan rate information is retrieved upon user request. In other embodiments, the loan rate information is obtained on user request, but if the current information has been obtained within a predefined period of time, it is considered current and new information is not obtained for that particular request. In yet other embodiments, the loan rate information is obtained at specific time intervals. When a user requests loan rate information, the information last retrieved is sent to the user requesting the information. In exemplary embodiments, there is a predefined list of sources or institutions from which the loan information is obtained.

In exemplary embodiments, the format in which the information will be received from each of the lenders is known. For example, the information may be retrieved from the institutions over the Internet. The received information may be in Hyper Text Markup Language (HTML). The format of the retrieved HTML web page is known. The information is known, because the information was obtained prior to implementing the information on the server. One method of doing this is go to the desired web page of each of the lender sites. The URL to get to the specific web page is stored. This URL is used to later obtain the information on an automated, real-time basis. The HTML source of the web page is examined to determine the location in the HTML source of the desired information. The desired loan rate information can then be automatically extracted from HTML source later retrieved from the lenders based on the known format of the HTML web pages of the lenders. Of course, testing must be done periodically in case the format of the lender web pages has changed. If so, the process must be repeated in order to modify the logic used to extract the loan rate information from the lender web pages.

In other embodiments, the format in which the information will be received from each specific lender is not known. In this case, the logic used to extract the information must be more generalized. Certain keywords can be searched for. When the keywords are found, the nearby text is examined to find the desired information.

The information retrieved from each of the sources is then formatted and displayed to the requester. In exemplary embodiments, a link for the source or institution is displayed. The user can select the link to go to the web page for the institution in order to obtain more detailed information about the loans offered by that particular institution.

If the user selected print rate information (yes in decision block 194), the logic moves to block 194 where the rate information is printed. If the information has been displayed within a predefined period of time, the information currently being displayed is printed. If the current information is stale (exceeds the predefined period of time), current rate information is obtained (as described above) from the sources, is formatted and is printed. After the requested function is performed (block 192 or block 196), the logic of FIG. 7 ends and processing returns to FIG. 6. As with the logic of FIG. 4, if a timeout occurs (yes in decision block 182), the logic of FIG. 6 ends and processing returns to FIG. 2 with an indication that a timeout occurred. If it is time to exit (yes in decision block 185), the logic of FIG. 6 ends and processing returns to FIG. 2 with an indication that a timeout did not occur and that it is time to exit.

Returning to FIG. 2, if the logic returns to FIG. 2 (from FIG. 4 or FIG. 6) with an indication that a timeout occurred (as determined in FIG. 4 or FIG. 6) based on inactivity for a predetermined period of time, the logic returns to block 100 where the user must login again. If the logic returned (from FIG. 4 or FIG. 6) with an indication that a timeout had not occurred but that an exit was desired, then the logic returned based on an exit indication and the logic of FIG. 2 ends.

While an illustrative and presently preferred embodiment of the invention has been described in detail herein, it is to be understood that the inventive concepts may be otherwise variously embodied and employed and that the appended claims are intended to be construed to include such variations except insofar as limited by the prior art.

What is claimed is:

1. A centralized computer-implemented method for automatically, generating a summary of loan rates offered by a plurality of lenders, the method comprising:
(a) obtaining a predefined list of a plurality of identifications of web pages of lenders from which loan rates are available;
(b) requesting the web pages identified for each of the lenders having available loan rates;
(c) receiving a web page response from the lenders;
(d) extracting, independently of operator intervention, the loan rates from each of the web page responses;
(e) grouping into a predefined format the extracted loan rates from each of the received lender web pages thereby generating a summary of loan rates for the plurality of lenders; and
(f) periodically repeating (a)-(e) to generate an updated summary of available loan rates from the lenders.

2. The method of claim 1, wherein (a)-(e) are repeated upon receipt of a user request for the summary of loan rates.

3. The method of claim 2, further comprising prior to receiving a user request for the summary of loan rates, logging in the user.

4. The method of claim 3, wherein a timeout occurs if there is no activity from the user for a predefined period of time.

5. The method of claim 4, further comprising logging in the user again if a timeout occurs.

6. The method of claim 3, wherein the logging in the user is a secure procedure.

7. The method of claim 1, wherein (a)-(e) are repeated periodically based on a timed basis.

8. The method of claim 1, wherein a format for each of the web pages of the lenders is known and the loan rates are extracted from each of the web pages based on the known format of the web page for the respective lender.

9. The method of claim 1, wherein the web page formats for each of the lenders are not known and the loan rates are extracted using an algorithm comprising scanning the web pages for key words.

10. The method of claim 1, further comprising displaying the formatted loan rate information.

11. The method of claim 1, further comprising printing the formatted loan rate information.

12. The method of claim 1, further comprising performing an administrative function.

13. The method of claim 12, wherein the administrative function is viewing information about a plurality of users.

14. The method of claim 13, further comprising displaying detailed information for a particular user selected from the plurality of users.

15. The method of claim 13, further comprising adding a note about a particular user selected from the plurality of users.

16. The method of claim 1, wherein the loan rates are mortgage loan rates.

17. The method of claim 1, wherein communications occur over a network.

18. The method of claim 17, wherein the network is the Internet.
